(19) United States
(12) Patent Application Publication
(10) Pub. No.: US 2023/0160450 A1
(43) Pub. Date: May 25, 2023

(54) Linear and Progressive Valve Assemblies For Digressive Shock Absorber

(71) Applicant: Edward Asbury, Tifton, GA (US)

(72) Inventor: Edward Asbury, Tifton, GA (US)

(21) Appl. No.: 17/532,202

(22) Filed: Nov. 22, 2021

(51) Int. Cl. F16F 9/348; F16F 9/18

(52) U.S. Cl. CPC F16F 9/3484; F16F 9/18; F16F 7/00

(57) ABSTRACT

A valving assembly to cause linear damping response in a shock absorber having a digressive piston, including a linearizing plate with a first side formed to contact a ridge of a digressive piston proximate an outer edge of the first side, a second side with a substantially flat surface, and flow openings to allow fluid flow between the first and second sides of the linearizing plate; and a valving assembly to cause progressive damping response in a shock absorber having a linear piston face, including a support disk at an end of the valving assembly opposite a piston, and a metering shim adjacent to the support disk, a side of the support disk facing the piston having a stepped down recess to seat the metering shim, and the metering shim having a smaller diameter than a cover shim to provide a gap between the support disk and the cover shim.

### CROSS-REFERENCE TO RELATED APPLICATIONS

Not applicable.

### FIELD OF INVENTION

The present general inventive concept relates to hydraulic shock absorbers, and, more particularly, to an improved damping valve stack in a hydraulic shock absorber.

### BACKGROUND

Hydraulic shock absorbers dampen the release of energy stored in a compressed spring. Typically, a piston with orifices formed therein is forced through a reservoir of oil, and the resistance of the oil to flow through the orifices increases as the piston's velocity, or shaft velocity, through the oil increases. Shaft velocity is the result of vertical wheel speed during suspension movements. It is the relationship between shaft velocity and damping force that defines a shock absorber's performance (valving). Deflective disk valving was developed as a way to spring load the orifices of the piston, which increased damping forces at slow shaft velocities, and at the same time eliminated the excessive forces created by high-speed shaft movements. The result of such valving was a more linear response to shaft velocity, as opposed to the progressive (nearly exponential) response of the early technology. Another development was digressive valving, which is substantially the opposite of progressive, wherein the rate of increase of damping force begins to digress, relative to shaft velocity, past a certain point of the shaft velocity. Shocks can have such a digressive response on compression of the shock, rebound, or both, depending on the piston design. With digressive valving, undesirable high-speed damping forces can be eliminated without sacrificing low speed control. In modern technology both linear and digressive pistons are utilized to achieve optimum performance in a wide variety of racing and OEM markets. Such tuning of the shocks can affect performance and handling on wide ranges of bumps and other irregular road/track surfaces. Typically, a digressive valving will sacrifice a smooth ride for increased control at lower forces, and the force response will begin to level off relatively with higher shaft velocity, while linear valving will sacrifice some handling at the lower shaft velocities, and maintain a relatively linear force response as the shaft velocity increases. With this in mind, it may be desirable to develop a shock absorber that could combine different and tunable linear, digressive, and/or progressive responses.

### BRIEF SUMMARY

According to various example embodiments of the present general inventive concept, a shock absorber valve assembly is provided that includes a linearizing plate configured to add linearization damping characteristics to a digressive bypass assembly, and/or a progressive support disk configured to add progressive damping characteristics to a linear valve assembly.

Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved by providing a valving assembly to cause linear damping response in a shock absorber having a digressive piston, the valving assembly including a linearizing plate having a first side configured to contact a ridge of a digressive piston proximate an outer edge of the first side, a second side, opposite the first side, configured to have a substantially flat surface, and a plurality of flow openings configured to allow fluid flow between the first and second sides of the linearizing plate.

The foregoing and/or other aspects and advantages of the present general inventive concept may also be achieved by providing a valving assembly to cause progressive damping response in a shock absorber having a linear piston face, the valving assembly including a support disk configured to be located at an end of the valving assembly opposite a piston of the shock absorber, and a metering shim configured to be placed adjacent to the support disk, wherein a side of the support disk facing the piston is configured with a stepped down recess configured to seat the metering shim therein, and wherein the metering shim is configured to have a smaller diameter than a cover shim arranged between the support disk and the piston so as to provide a predetermined gap between the support disk and the cover shim.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates an assembled view of a typical shock absorber piston assembly;

FIG. 2 illustrates an exploded view of a conventional shock absorber piston assembly having a digressive compression and rebound assembly;

FIG. 3 illustrates an exploded view of a linearized digressive compression assembly according to an example embodiment of the present general inventive concept;

FIG. 4A illustrates an exploded view of a portion of the compression assembly components of FIG. 3 along with a digressive piston, and FIG. 4B illustrates a plan view of a linearizing plate according to an example embodiment of the present general inventive concept;

FIGS. 5A-B respectively illustrate exploded and assembled cross-sections of the compression assembly components of FIG. 4A, FIG. 5C illustrates a partially exploded cross-section of an additional linearizing plate assembly being provided on the rebound side of the digressive piston according to an example embodiment of the present general inventive concept, and FIG. 5D illustrates a cross-section of the assembled components of FIG. 5C;

FIG. 6 illustrates an exploded view of a conventional shock absorber piston assembly having a linear compression and rebound assembly;

FIG. 7A illustrates an exploded view of a linear compression assembly having a progressive damping element according to an example embodiment of the present general inventive concept, and FIG. 7B illustrates an exploded view of progressive damping elements provided in both linear compression and rebound assemblies according to an example embodiment of the present general inventive concept;

FIG. 8 illustrates an exploded view of a portion of the compression assembly components of FIG. 7A;

FIGS. 9A-B respectively illustrate exploded and assembled cross-sections of the compression assembly components of FIG. 8; and

FIG. 10 illustrates a cross-section of the compression assembly components of FIG. 9B showing flexure of the cover shim toward a progressive support disk in response to force of fluid flow.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

In shock assemblies, “bleed” is how much fluid a shock will bypass through a piston and valve stacks as it moves in either direction (compression and rebound). With a linear piston having a substantially flat face, a small bleed hole in the piston, along with a pyramid stack of valving disks, produces a linear damping response. With a digressive piston having a piston ring or ridge and corresponding lowered area or recess within the ridge allowing preloading of the pyramid stack, small valving disks may be placed in the recess to decrease the preload and simulate a linear damping response. Linear pistons may have more and larger bleed holes, and multiple pyramid stacks of valving disks, to produce a progressive damping response, while sacrificing low speed control.

In digressive valve stacks the bypass disk, or bypass bleed plate, affects low to mid-range rebound. The amount of bypass built into either linear or digressive valvings directly affects the low speed performance. With linear designs the bypass flow is balanced with the strength of the valve stack. It is the amount of bypass area that sets the parameters for the valve stack design with both linear and digressive pistons. In some configurations the bypass plate's thickness and number of slots, or flow openings, in its perimeter determine the bypass area. Testing has shown that more bypass area in the valve stack means less low speed damping force, and less bypass area means more low speed damping force. In other configurations the bypass plate, or bypass shim, is formed by a cover plate such that the cover plate diameter determines the bypass area due to open area of fluid holes. Typically, in such a valve stack, there are a variety of shims that are ordered (moving away from the piston) as a pre-load shim, the bypass shim, the cover shim, and a support shim. The number of various ones of these shims, as well as the diameters and thicknesses, vary according to different particular valve stacks. In a standard digressive stack, with the pre-load plate next to the piston, more thickness of the pre-load plate causes the cover plate to have less pre-load, and therefore less overall damping force in the stack. The bleed plate controls the low-speed damping forces, wherein more total bleed area means less damping force, and less bleed means more damping force. The cover plate or shim determines the overall force of the stack once the stack opens. Until the stack opens, only the bleed effects the valving. The support plate or brake washer fine tunes the high-speed damping force.

Various example embodiments of the present general inventive concept may provide a novel valve stack that improves performance by providing a shock absorber valve assembly that includes a linearizing plate, or linearization conversion plate, configured to add linearization damping characteristics to a digressive bypass assembly, and/or a progressive support disk configured to add progressive damping characteristics to a linear valve assembly. It is noted that the terms shock and shock absorber may be used interchangeably in the descriptions that follow. The terms disk, shim, plate, etc., may also be used interchangeably in portions of these descriptions.

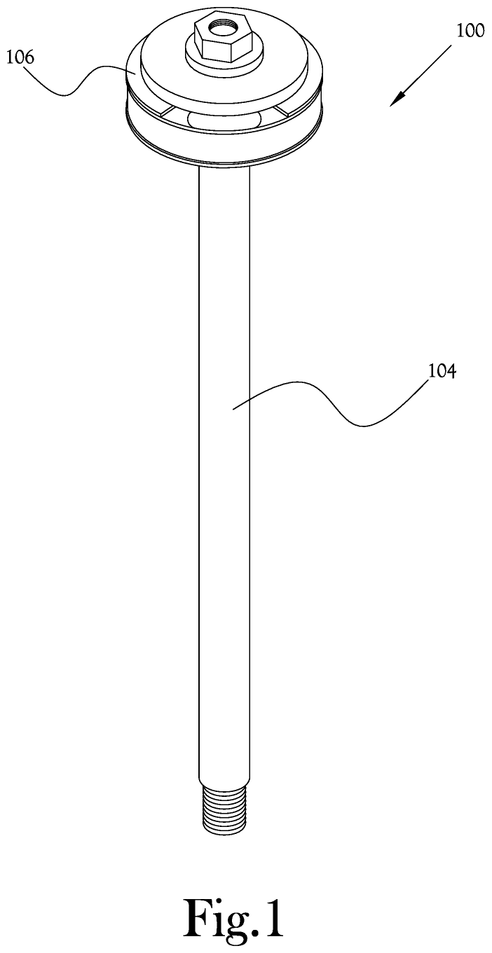

FIG. 1 illustrates an assembled view of a typical shock absorber piston assembly. As illustrated, the shock absorber piston assembly 100 includes a piston rod 104 on with a piston/valving assembly 106 mounted thereon. The piston/valving assembly 106 has compression assembly valving on one side of the piston, and rebound assembly valving on the other side of the piston.

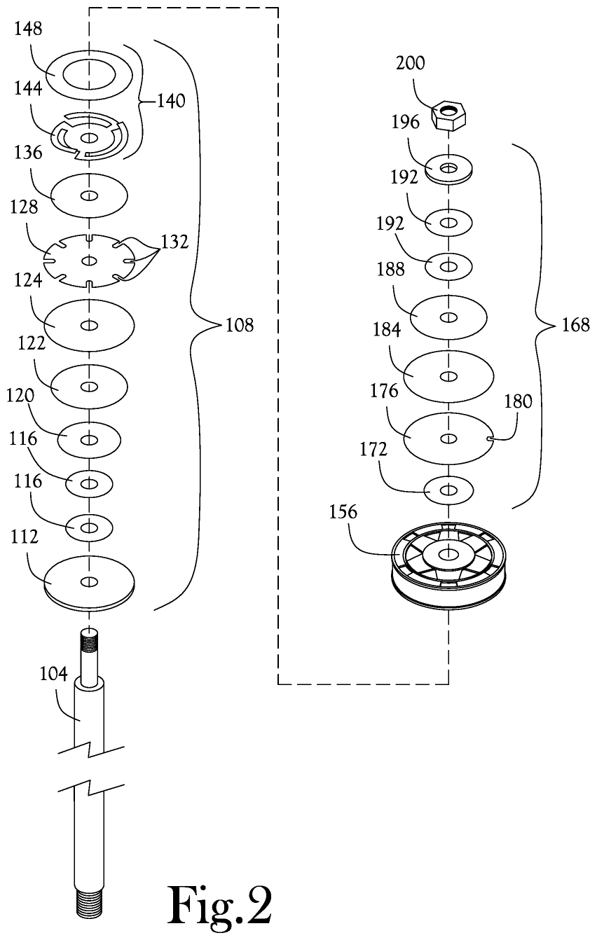

FIG. 2 illustrates an exploded view of a conventional shock absorber piston assembly having a digressive compression and rebound assembly. It is noted that many of the drawings shown herein, including FIG. 2, show the shock absorber piston assembly in an inverted view, or upside down relative to how they would be arranged when installed, simply to better show various piston side characteristics of some of the components of the assembly. As illustrated in FIG. 2, a digressive piston 156 is provided with a compression assembly 108 on one side, and a rebound assembly 168 on the other side. Digressive pistons are formed with a ridge on the surface, and a corresponding recess formed inside the piston ridge and having a plurality of bleed or flow openings, which allows pre-loading of shims to affect the damping curve. Digressive shocks are produced by preloading the valve disks, typically between 0.002″ and 0.015″, in the recess inside the surface ridge on the digressive piston. The amount of preload changes the breakover point of the damping curve. Small variations in the preload thickness of these valve disk stacks may produce highly varying damping loads. Linear shocks have a flat surface of the piston, and thus variations in the valve disks are needed to try and create the desired damping curve, which will be described herein.

The compression assembly 108 of this shock is a conventional digressive compression only bypass assembly including (listed in order in the direction of the piston 156) a support disk 112, a pair of clamp shims 116, a support shim 120, another support shim 122 of larger diameter than the support shim 120, a cover shim 124, a bleed shim 128 having a plurality of bleed openings 132 arranged around a perimeter of the bleed shim 128, a preload shim 136, a check valve spring 144, and a check valve plate 148 that is configured to be received in a recessed ring on the compression side face of the piston 156. The check valve spring 144 and check valve plate 148 form a check valve assembly 140. The check valve plate 148 is a compression only bypass (COB) valve.

The rebound assembly 168 of this shock, located on the rebound side of the piston 156, includes (in order leading away from the piston 156) a preload shim 172, a bleed shim 176 having a bleed opening 180 located on a perimeter of the bleed shim 176, a cover shim 184, a support shim 188, a pair of clamp shims 192, and a brake washer 196. A nut 200 is arranged to hold the piston assembly together on the piston rod 104.

During a compression operation of the shock, the check valve plate 148, which is configured to be seated in a corresponding recess of the digressive piston 156 to inhibit fluid flow through flow openings formed in that recess of the digressive piston 156, opens up to allow more fluid to flow. The bleed is additive, and in this example assembly the flow openings in the bleed shim 128 in the compression assembly 108 are equal to approximately 6 mm², and the opening in the bleed shim 176 in the rebound assembly 168 is equal to approximately 0.27 mm². Thus, during compression, this shock assembly has 6.27 mm² of bleed area. When it is rebounding, the check valve spring 144 causes the check valve plate 148 to full seat in the digressive piston 156, shutting the flow openings formed in the recess that receives the check valve plate 148. Thus, there is only 0.27 mm² of bleed area in the rebound. This is generally the configuration found in the BILSTEIN COB digressive piston assembly.

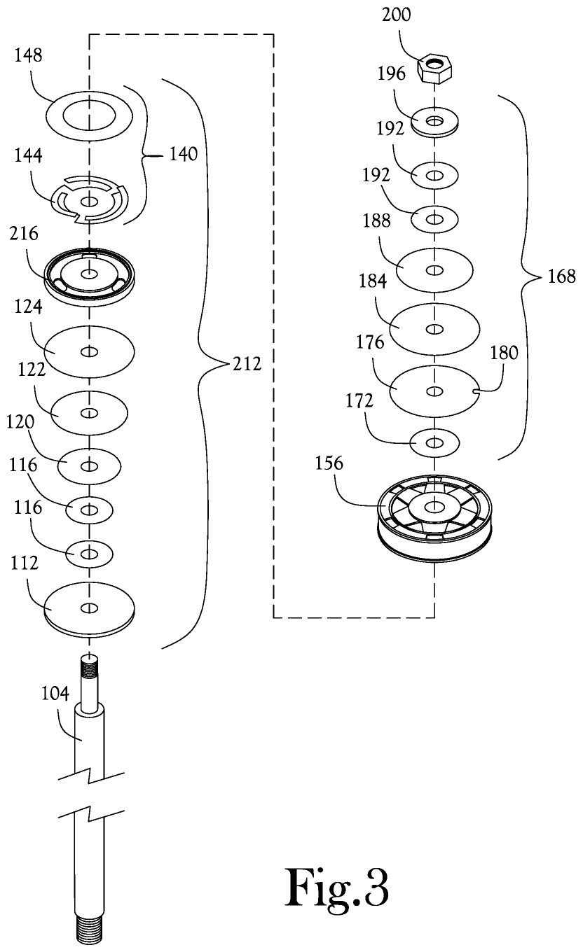

FIG. 3 illustrates an exploded view of a linearized digressive compression assembly according to an example embodiment of the present general inventive concept. In this example embodiment, a compression assembly 212 includes many of the same components as the conventional compression assembly 108 illustrated in FIG. 2, but the bleed shim 128 and preload shim 136 have been replaced by a linearizing plate 216 that is configured to cause linear damping response of the digressive piston assembly.

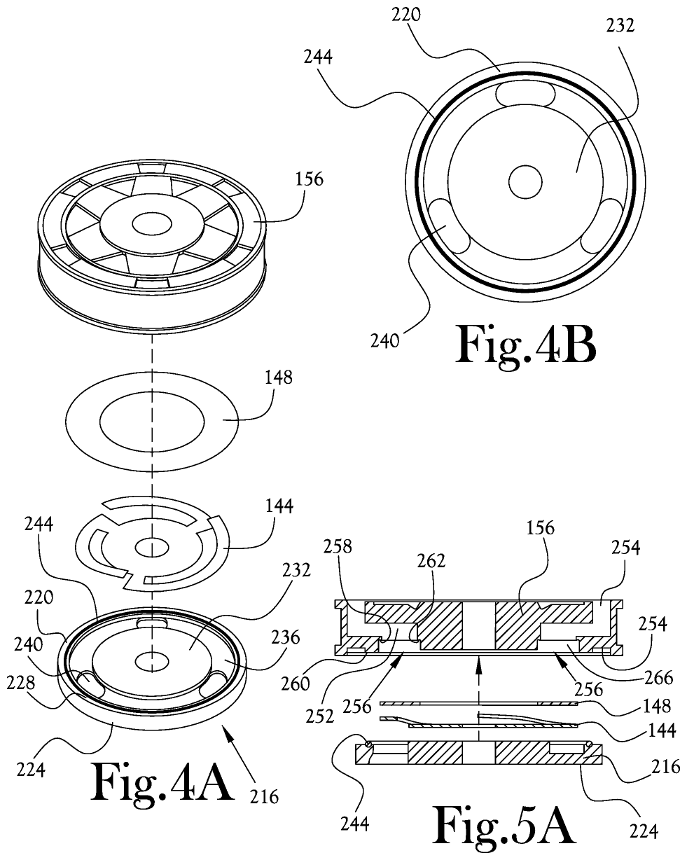

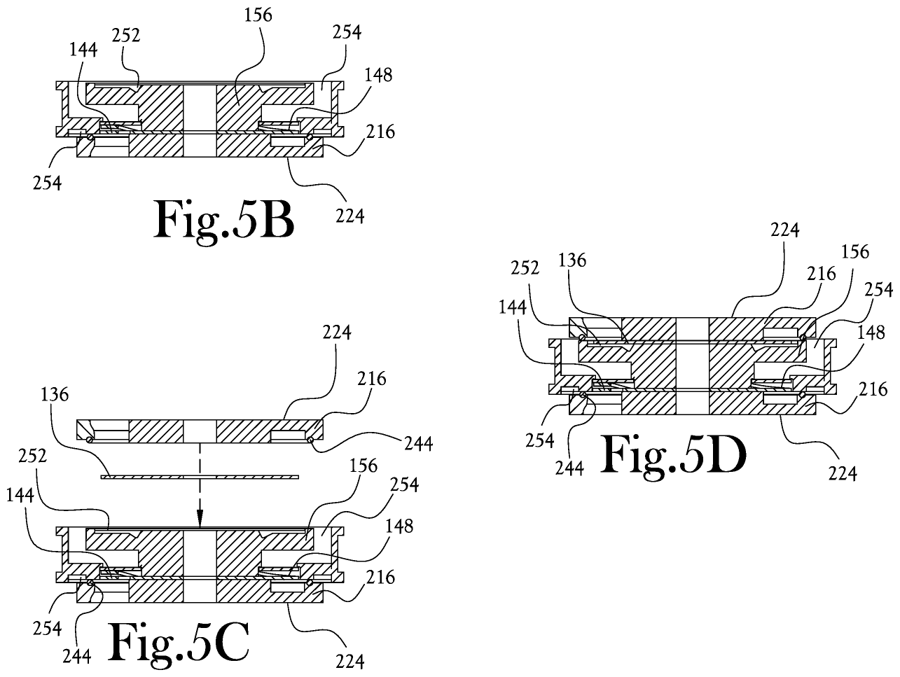

FIG. 4A illustrates an exploded view of a portion of the compression assembly components of FIG. 3. In the example embodiment illustrated in FIG. 4A, the linearizing plate 216 is configured with a first side 220 that is arranged to face the piston 156, and a second side 224, that has a substantially flat surface, opposite the first side 220 of the linearizing plate 216 and arranged to face away from the piston 156. The first side 220 of the linearizing plate 216 is formed with an inner surface 232 formed around the central hole that receives the piston rod 104, an outer ridge 228, and a channel 236 formed between the inner surface 232 and outer ridge 228. A plurality of flow holes 240 are formed in the channel 236 to allow fluid flow therethrough during travel of the piston 156 through the shock absorber. The outer ridge 228 of the first side 220 of the linearizing plate 216 is configured to contact a ridge 260 (illustrated in FIGS. 5A-B) on the corresponding side of the digressive piston 156 to prohibit any of the fluid flowing through the plurality of flow holes 240 in the channel 236 from going outside of the ridge 260 of the digressive piston 156 when the linearizing plate 216 is moved into contact with the piston 156. In various example embodiments, such as illustrated in FIGS. 4A and 4B, a gasket or sealing ring 244 can be provided on a surface of the outer ridge 228 of the linearizing plate 216 to form a seal with the ridge 260 of the digressive piston 156 to aid in the prevention such fluid flow. In various example embodiments a groove 248 may be formed on the outer ridge 228 to seat the sealing ring 244 therein, while in other example embodiments the sealing ring 244 may be simply adhered to the flat surface of the outer ridge 228. FIG. 4B illustrates a plan view of the first side (piston facing side) 220 linearizing plate 216 according to an example embodiment of the present general inventive concept. In various example embodiments of the present general inventive concept, the inner surface 232 on the first side 220 of the linearizing plate 216 may project higher over the channel 236 than does the outer ridge 228, to better interact with the check valve spring 144 and check valve plate 148 of the compression assembly 212 when the linearizing plate 216 is pressed toward the digressive piston 156. When such contact is made, the flat surface of the second side 224 of the linearizing plate 216 effectively forms a flat face of the piston 156, increasing linear damping force of the compression assembly 168 when so arranged. The linearizing plate 216 can be used on either or both sides of the digressive piston to increase linear damping response. A conventional linear stack may be provided on the side of the linearizing plate 216 opposite the piston, with the bleed set by the diameter of a cover shim relative to the flow openings formed on that side of the linearizing plate 216.

FIGS. 5A-B respectively illustrate exploded and assembled cross-sections of the compression assembly components of FIG. 4A, FIG. 5C illustrates a partially exploded cross-section of an additional linearizing plate assembly being provided on the rebound side of the digressive piston according to an example embodiment of the present general inventive concept, and FIG. 5D illustrates a cross-section of the assembled components of FIG. 5C. As illustrated in FIGS. SA-B, when the linearizing plate 216 and digressive piston 156 are forced together, the check valve spring 144 and check valve plate 148 are captured inside a piston recess 256 formed inside the piston ridge 260, restricting some of the fluid flow through the inner flow openings 252 on the compression side of the digressive piston 156. The digressive piston 266 illustrated in FIGS. SA-D is formed on one side with a circular channel 266 inside the piston recess 256 to work with a COB valving assembly. The channel 266 has an outer lip 258 and an inner lip 262 formed at a “bottom” of the channel 266, i.e., the deep part of the channel 266, on which the check valve plate 148 rests when biased in the direction of the piston 156 by the check valve spring 144. The inner portion of the check valve spring 144 is effectively sandwiched between the inner surface 232 of the linearizing plate 216 and the center portion of the piston 156 rising an inner border of the channel 266. With a digressive piston such as the piston 156, the inner flow openings 252 formed inside the piston ridge on one side of the digressive piston lead to outer flow openings 254 formed outside the piston ridge on the other side of the digressive piston. Roughly speaking, there is approximately 150 mm² of flow area going in both directions through the digressive piston 156. The check valve plate 148 is configured to be seated in the piston channel 266 by the check valve spring 144 to restrict fluid flow through the flow openings in the piston recess 256 during some phases of the shock response. As illustrated in FIG. 5B, with the linearizing plate 216 pressed against the digressive piston 156, the sealing ring 244 on the outer ridge 228 of the linearizing plate 216 forms a seal with the piston ridge 260, preventing flow from either side over the piston ridge 260 itself. The channel 236 is configured to allow fluid flow about the edges of the check valve plate 148 and through the inner flow openings 252 of the digressive piston 156. As also illustrated in FIG. 5B, when the linearizing plate 216 is pressed fully against the digressive piston 156, the flat second side 224 of the linearizing plate 216 effectively forms a linear piston face, causing linear response of the digressive piston 156. While the linearizing plate 156 forming a linear face on a digressive piston 156 is only shown on the compression side in this illustrated example, it could just as easily be located on the rebound side of the digressive piston, or on both sides of the digressive pistons (as illustrated in FIGS. 5C-D). As illustrated in FIG. 5B, the flow holes 240 of the linearizing plate 216 are configured to channel fluid to the inner flow openings 252 of the digressive piston, thus providing similarly configured linear piston faced flow openings. A conventional linear stack, with the bleed set by the diameter of the cover shim 124 covering the flow holes 240, can therefore be provided on the flat second side 224 of the linearizing plate 216, as illustrated in FIG. 3. In various example embodiments, the flow holes 240 of the linearizing plate 216 may be configured to have 150 mm² of flow area, to match the flow area of the digressive piston 156. As illustrated in FIGS. 5C-D, the linearizing plate 216 can also be used on the rebound side of the digressive piston 156 to cause a linear damping response on the rebound side as well. Although the rebound side of the digressive piston 156 has the piston ridge 260 which allows the digressive characteristics, the rebound side does not have the channel 266 to accommodate the check valve assembly 140 that is provided in the compression assembly 212 of FIG. 3. Therefore, instead of having a check valve spring 144 and check valve plate 148 between the linearizing plate 216 and the digressive piston 156, a preload shim 136 may be placed between the linearizing plate 216 and the digressive piston 156. The preload shim 136 is held between the inner surface 232 of the linearizing plate 216 and the extending central portion of the digressive piston 156 inside the rebound side piston ridge 260. The size of the preload shim 136 may be chosen to cause the desired blow characteristics through the linearizing plate 216 and digressive piston 156. Otherwise, the fit and operation of the linearizing plate 216 on the rebound side of the digressive piston 156 is much the same as that on the compression side. Thus, the linearizing plate 216 may be used on either or both sides of a digressive piston.

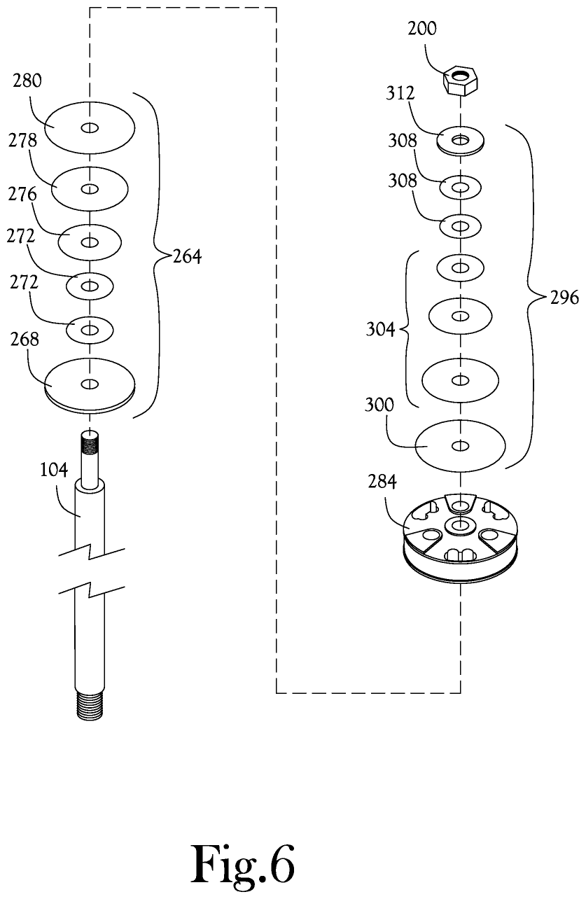

FIG. 6 illustrates an exploded view of a conventional shock absorber piston assembly having a linear compression and rebound assembly. As illustrated in FIG. 6, a linear piston 284 is provided with a compression assembly 264 on one side, and a rebound assembly 296 on the other side. The compression assembly 264 of this shock is a conventional linear compression assembly including (listed in order in the direction of the piston 284) a support disk 268, a pair of clamp shims 272, a support shim 276, another support shim 278 having a larger diameter than the support shim 276, and a cover shim 280 configured to contact the compression side of the linear piston 284.

The rebound assembly 296 of this shock, located on the rebound side of the piston 284, includes (in order leading away from the piston 284) a cover shim 300, a plurality of support shims 304 formed with decreasing diameter moving away from the rebound side of the piston 284, a pair of clamp shims 308, and a brake washer 312. A nut 200 is arranged to hold the piston assembly together on the piston rod 104.

The basic difference between the linear piston 284 and the digressive piston 156 is the flat surface of the linear piston 284. Because the linear piston 284 does not have the piston ridge 260 and corresponding piston recess 256 inside the ridge 260, there is no way to pre-load the shims. The linear piston 284 works by the cover shims on the flat surface of the linear piston 284 simply opening, and from the diameter of the cover shims, which determine how much of the flow openings in the linear piston 284 are covered by the cover shims.

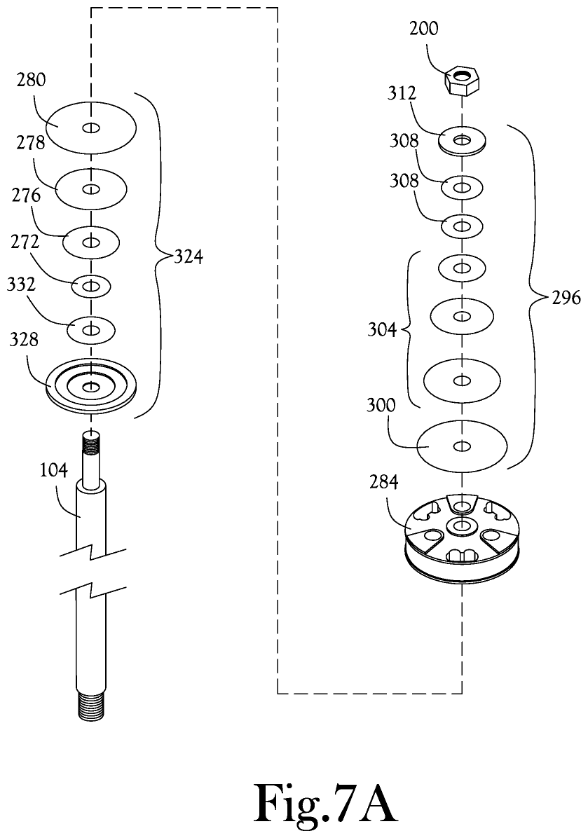

FIG. 7A illustrates an exploded view of a linear compression assembly having a progressive damping element according to an example embodiment of the present general inventive concept, and FIG. 7B illustrates an exploded view of progressive damping elements provided in both linear compression and rebound assemblies according to an example embodiment of the present general inventive concept. In the example embodiment illustrated in FIG. 7A, a compression assembly 324 includes many of the same components as the conventional compression assembly 264 illustrated in FIG. 6, but the support disk 268 has been replaced by a progressive support disk 328, or progressive plate, that is configured to increase progressive damping response of the linear piston assembly. In this example embodiment one of the clamp shims 272 of the compression assembly 264 of FIG. 6 has also been omitted, and a metering shim 332 has been added to interact with the progressive support disk 328 to tune the damping effect of the progressive support disk 328. Such tuning may be done by using different thickness of the metering shim 332, and/or providing different quantities of metering shims. As illustrated in FIG. 7B, a rebound assembly 326 may include substantially the same components as the compression assembly 324, in a mirror image leading away from the linear face piston 284. Therefore, a valving assembly including the progressive support disk 328 may be located on either or both the compression and rebound sides of the linear piston 284.

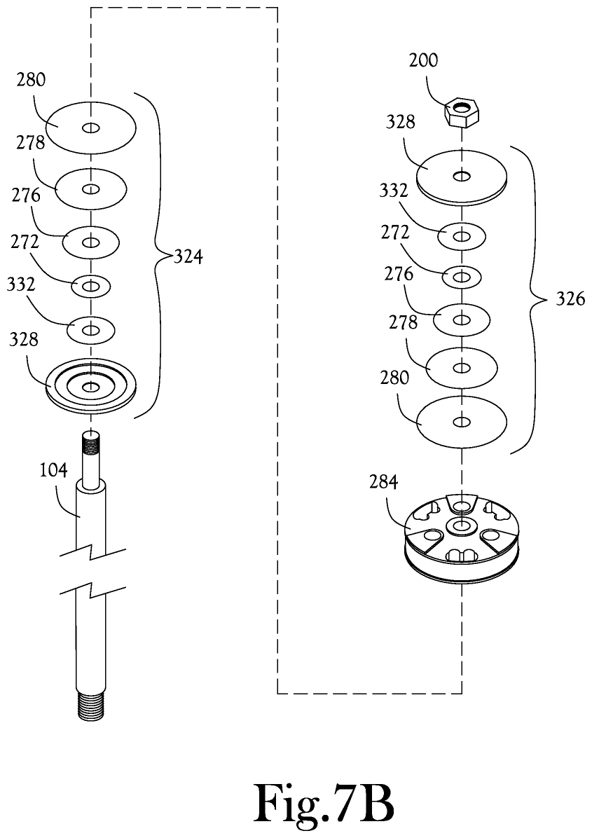

FIG. 8 illustrates an exploded view of a portion of the compression assembly 324 components of FIG. 7A. As illustrated in FIG. 8, the cover shim 280, support shims 278 and 276, and clamp shim 272 decrease in diameter in a direction away from the linear piston 284, this portion of the compression assembly 324 ending with the metering shim 332 and progressive support disk 328. The side of the progressive support disk 328 facing the piston 284 is formed to be stepped down twice in the direction of the opening through which the piston rod 104 passes through the progressive support disk 328. As illustrated in FIG. 8, the side of the progressive support disk 328 facing the piston 284 is configured with an outer surface 334 forming an outer perimeter of that side of the progressive support disk 328, a middle surface 336 stepped down from the outer surface 334, and an inner surface 338 stepped down from the middle surface 336. The inner surface 338 of the progressive support disk 328 is configured to seat the metering shim 332 therein. Thus, instead of having a flat surface, such as that shown on the piston side of the support disk 268 of FIG. 6, the progressive support disk 328 has a progressive surface. Therefore, by replacing the support disk 268 with the progressive support disk 328 and metering shim 332, a linear damping response can be made more progressive.

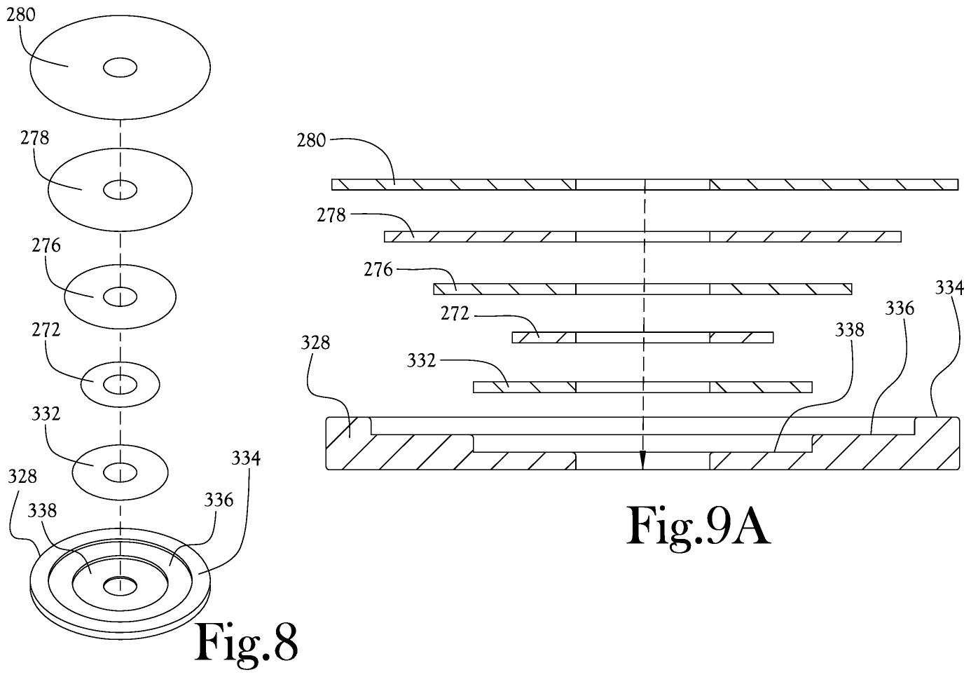

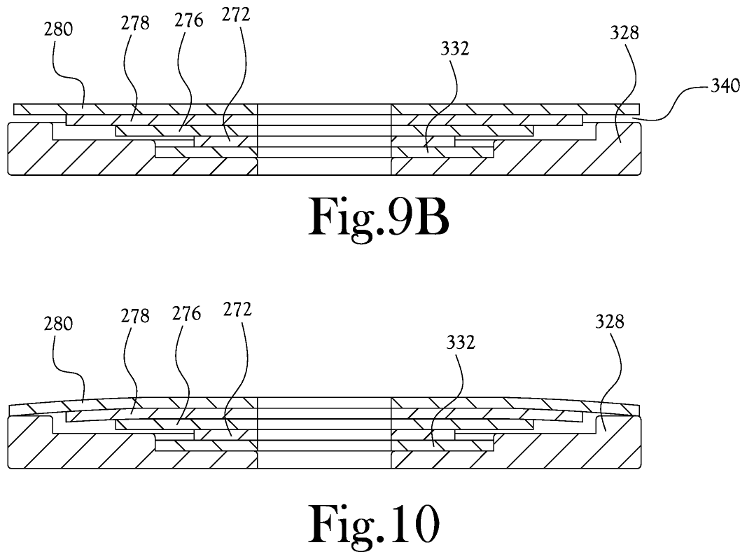

FIGS. 9A-B respectively illustrate exploded and assembled cross-sections of the compression assembly components of FIG. 8. As illustrated in FIGS. 9A-B, a thickness of the metering shim 332 determines the amount of a vertical gap 340 between the cover shim 280 and the outer surface 334 of the progressive support disk 328. The gap 340 can be made greater by increasing the thickness of the metering shim 332, or metering shims 332, or can be made smaller by decreasing the thickness of the metering shim(s) 332. When the force on the cover shim 280 is sufficient to flex the edges of the cover shim 280 so as to contact the outer surface 334 of the progressive support disk 328, the flow window is then fixed. FIG. 10 illustrates a cross-section of the compression assembly components of FIG. 9B showing the flexure of the cover shim 280, as well as the support shims 276 and 278, toward the progressive support disk 328 in response to force of fluid flow. From the point at which the cover shim 280 contacts the progressive support disk 328, the flow window will not change. From that point on, there will a progressive change in the compression force, which in some example embodiments will be of some polynomial approximate to cubed. Although the progressive assembly of this example embodiment is illustrated as being located on the compression side of the piston, it could also be arranged on the rebound side, or on both sides of the piston. With various example embodiments of the present general inventive concept using such a progressive support disk, progressive compression can be achieved independently from what bleed is chosen, or what clamp shim diameter is present, and the assembler is given more flexibility in the support shim stack between the progressive support disk and the piston. By varying the gap 340, the progressive response at a given shaft speed may be as much as tripled, or more. For example, a typical digressive piston valved to make 125 pounds of force at 10 inches/s of shaft velocity may make 165 pounds of force at 20 inches/s of shaft velocity. A true linear assembly valved to make 125 pounds of force at 10 inches/s of shaft velocity will make approximately 250 pounds of force at 20 inches/s of shaft velocity. An assembly employing a progressive support disk of the present general inventive concept that makes 125 pounds of force at 10 inches/s may make, for example, as much as 400-500 pounds of force at 20 inches/s of shaft velocity.

Thus, a stepped progressive support disk with a metering shim as described herein can be used in place of a conventional support disk. The metering shim may be used to set a gap between a cover shim and the progressive support disk, and the gap can be varied by changing the thickness of the metering shim or metering shims. When the cover shim flexes enough to come in contact with the progressive support disk, the flow window is fixed, and from that point on a progressive force response is achieved. In this way, progressive compression is achieved independently of a chosen bleed or clamp shim diameter, and flexibility is added in the stack underneath, in the support disk.

In various example embodiments a metering shim 332 may be provided adjacent to a conventional support disk 268 having a flat surface to produce the aforementioned gap between the cover shim 280 and the support disk 268, and to thus introduce progressive damping force to a linear stack assembly.

Various example embodiments of the present general inventive concept may provide a valving assembly to cause linear damping response in a shock absorber having a digressive piston, the valving assembly including a linearizing plate having a first side configured to contact a ridge of a digressive piston proximate an outer edge of the first side, a second side, opposite the first side, configured to have a substantially flat surface, and a plurality of flow openings configured to allow fluid flow between the first and second sides of the linearizing plate. The first side of the linearizing plate may be configured to contact the ridge of the digressive piston so as to prohibit fluid flow between the first side of the linearizing plate and the ridge of the digressive piston. The valving assembly may further include a sealing ring provided proximate the outer edge of the first side of the linearizing plate and configured to seal a space between the first side of the linearizing plate and the ridge of the digressive piston. The first side of the linearizing plate may include an outer ridge, an inner surface, and a channel formed between the outer ridge and inner surface, the plurality of flow openings being located in the channel. The valving assembly may further include a sealing ring provided on the outer ridge and configured to seal a space between the outer ridge of the linearizing plate and the ridge of the digressive piston. The valving assembly may further include a groove formed on the outer ridge and configured to at least partially receive the sealing ring. The inner surface may project higher than the outer ridge. The inner surface may be configured to compress a check valve spring and check valve plate against a surface of the digressive piston inside the ridge of the digressive piston. The flow openings may be configured to have substantially the same flow area as a flow area of the digressive piston inside the ridge of the digressive piston. The plurality of flow openings may be configured to allow control of bleed by varying an outer diameter of an adjacent cover shim. The valving assembly may further include another linearizing plate arranged on a ridge on an opposite side of the digressive piston in a substantially mirrored arrangement, so as to form a split-bleed linear piston assembly with the digressive piston.

Various example embodiments of the present general inventive concept may provide a valving assembly to cause progressive damping response in a shock absorber having a linear piston face, the valving assembly including a support disk configured to be located at an end of the valving assembly opposite a piston of the shock absorber, and a metering shim configured to be placed adjacent to the support disk, wherein a side of the support disk facing the piston is configured with a stepped down recess configured to seat the metering shim therein, and wherein the metering shim is configured to have a smaller diameter than a cover shim arranged between the support disk and the piston so as to provide a predetermined gap between the support disk and the cover shim. The side of the support disk facing the piston may include an outer surface, a middle surface stepped down from the outer surface, and an inner surface stepped down from the middle surface, wherein the inner surface is configured to seat the metering shim therein. The middle surface may be configured to have a diameter larger than a plurality of shims between the support disk and the cover shim, such that the cover shim contacts the outer surface when the cover shim flexes so as to contact the support disk. The valving assembly may be provided on both sides of the linear piston to cause progressive damping response on both compression and rebound sides of the linear piston. The linear piston face may be formed by a linearizing plate provided adjacent to a linear piston. Thus, valving assemblies on both the compression and rebound sides of a piston may include the linearizing plate and/or progressive support disk, depending on the type of piston and desired responses.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A valving assembly to cause linear damping response in a shock absorber having a digressive piston, the valving assembly comprising:
a linearizing plate comprising:
a first side configured to contact a ridge of a digressive piston proximate an outer edge of the first side,
a second side, opposite the first side, configured to have a substantially flat surface, and
a plurality of flow openings configured to allow fluid flow between the first and second sides of the linearizing plate.

2. The valving assembly of claim 1, wherein the first side of the linearizing plate is configured to contact the ridge of the digressive piston so as to prohibit fluid flow between the first side of the linearizing plate and the ridge of the digressive piston.

3. The valving assembly of claim 2, further comprising a sealing ring provided proximate the outer edge of the first side of the linearizing plate and configured to seal a space between the first side of the linearizing plate and the ridge of the digressive piston.

4. The valving assembly of claim 1, wherein the first side of the linearizing plate comprises:
an outer ridge,
an inner surface, and
a channel formed between the outer ridge and inner surface, the plurality of flow openings being located in the channel.

5. The valving assembly of claim 4, further comprising a sealing ring provided on the outer ridge and configured to seal a space between the outer ridge of the linearizing plate and the ridge of the digressive piston.

6. The valving assembly of claim 5, further comprising a groove formed on the outer ridge and configured to at least partially receive the sealing ring.

7. The valving assembly of claim 4, wherein the inner surface projects higher than the outer ridge.

8. The valving assembly of claim 4, wherein the inner surface is configured to compress a check valve spring and check valve plate against a surface of the digressive piston inside the ridge of the digressive piston.

9. The valving assembly of claim 1, wherein the flow openings are configured to have substantially the same flow area as a flow area of the digressive piston inside the ridge of the digressive piston.

10. The valving assembly of claim 1, wherein the plurality of flow openings are configured to allow control of bleed by varying an outer diameter of an adjacent cover shim.

11. The valving assembly of claim 1, further comprising another linearizing plate arranged on a ridge on an opposite side of the digressive piston in a substantially mirrored arrangement, so as to form a split-bleed linear piston assembly with the digressive piston.

12. A valving assembly to cause progressive damping response in a shock absorber having a linear piston face, the valving assembly comprising:
a support disk configured to be located at an end of the valving assembly opposite a piston of the shock absorber; and
a metering shim configured to be placed adjacent to the support disk;
wherein a side of the support disk facing the piston is configured with a stepped down recess configured to seat the metering shim therein; and
wherein the metering shim is configured to have a smaller diameter than a cover shim arranged between the support disk and the piston so as to provide a predetermined gap between the support disk and the cover shim.

13. The valving assembly of claim 12, wherein the side of the support disk facing the piston comprises:
an outer surface,
a middle surface stepped down from the outer surface, and
an inner surface stepped down from the middle surface,
wherein the inner surface is configured to seat the metering shim therein.

14. The valving assembly of claim 13, wherein the middle surface is configured to have a diameter larger than a plurality of shims between the support disk and the cover shim, such that the cover shim contacts the outer surface when the cover shim flexes so as to contact the support disk.

15. The valving assembly of claim 12, wherein the valving assembly is provided on both sides of the linear piston to cause progressive damping response on both compression and rebound sides of the linear piston.

16. The valving assembly of claim 12, wherein the linear piston face is formed by a linearizing plate provided adjacent to a linear piston.
